(19) United States
(12) Patent Application Publication
(10) Pub. No.: US 2004/0151532 A1
(43) Pub. Date: Aug. 5, 2004

(54) Arrangement for a binder

(76) Inventor: Tore Haraldsson, Smalandsstenar (SE)

Correspondence Address: ORUM & ROTH, 53 W. JACKSON BLVD, CHICAGO, IL, 60604, US

(21) Appl. No.: 10/763,490

(22) Filed: Jan. 23, 2004

(30) Foreign Application Priority Data
Jan. 24, 2003 (SE) 0300179-9

(51) Int. Cl. B42F 3/04

(52) U.S. Cl. 402/35

(57) ABSTRACT

The invention relates to an arrangement (1) for a locking mechanism (2) for a binder (3), which comprises a locking rail (5) that is detachably interconnectable with a number of hooks (4), which rail is capable of displacement by means of a manually actuated, spring-operated locking button (6).

In accordance with the invention, the locking button (6) is executed in such a way that it performs both a spring function and a guiding function for the axially (7-8) mobile locking rail (5) and is detachably attachable to the locking rail (5) at its one end.

An arrangement for a locking mechanism for a binder which comprises a locking rail that is detachably interconnectable with a number of hooks, which rail is capable of displacement by means of a manually actuated, spring-actuated locking button.

A locking mechanism, which is provided on binders, is so arranged as to be capable of locking the binder in various positions between fully folded and closed and fully unfolded and opened. In order to achieve this desired function, different variations of a solution are available which preferably comprise a locking rail capable of displacement axially along the back of the binder and accommodated therein. Actuation thereof is achieved by means of a manually actuated locking button. The locking button was previously designed in such a way that it functioned with a spring function for the purpose of securely locking the aforementioned arranged hooks to the locking rail with the help of a separately arranged spring, that is to say a spring function was achieved thanks to the arrangement of an aforementioned spring. The assembly of the mechanism and the aforementioned locking button and spring, which were executed of various materials, was time-consuming, and the resulting solution was not as stable and durable as desired. Polyamide, hard-rolled steel and spring steel were among the materials used for this purpose to form the aforementioned mechanism, that is to say three different component parts which were assembled and were perhaps not as stable and durable as desired, and as environmentally friendly. An example of a previously disclosed locking mechanism of this kind is illustrated in U.S. Pat. No. 4,352,592 A.

The principal object of the present invention is thus, in the first instance, to make available a locking mechanism of the aforementioned kind, which, among other things, solves the above-mentioned problems in a simple and effective way.

The aforementioned object is achieved by means of an arrangement in accordance with the present invention, which is characterized essentially in that the locking button is executed in such a way that it performs both a spring function and a guiding function for the axially mobile locking rail and is detachably attachable to the locking rail at its one end.

This means that only two component parts, the locking button together with the locking rail, produce a function with springing. The entirely novel feature is that the button has been combined with a spring with two functions. Simplified assembly is achieved in this way, but also simpler and better function.

The invention is described below as a preferred illustrative embodiment, in conjunction with which reference is made to the accompanying drawings, in which

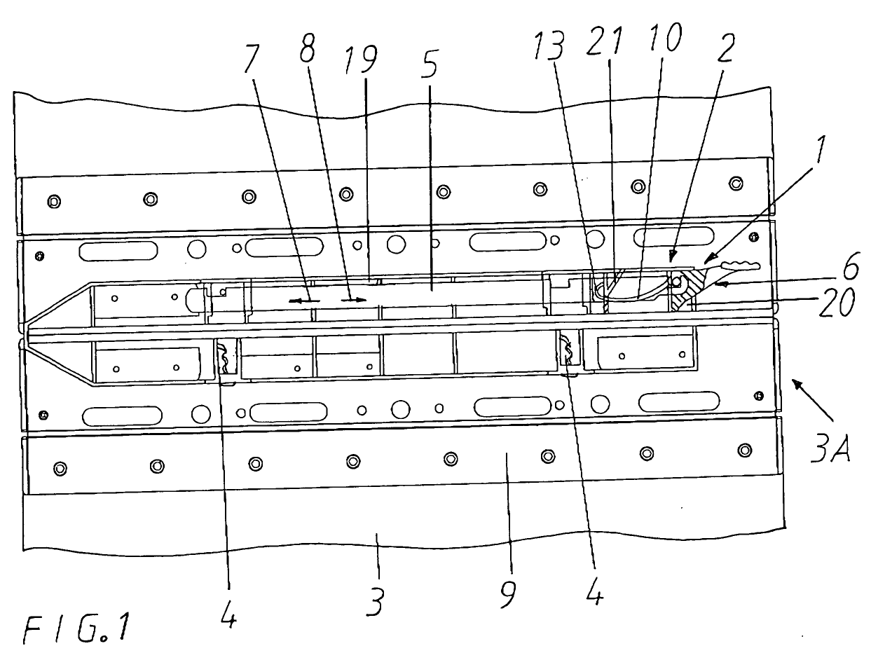

FIG. 1 shows the back of a binder in the fully unfolded position with the mechanism illustrated;

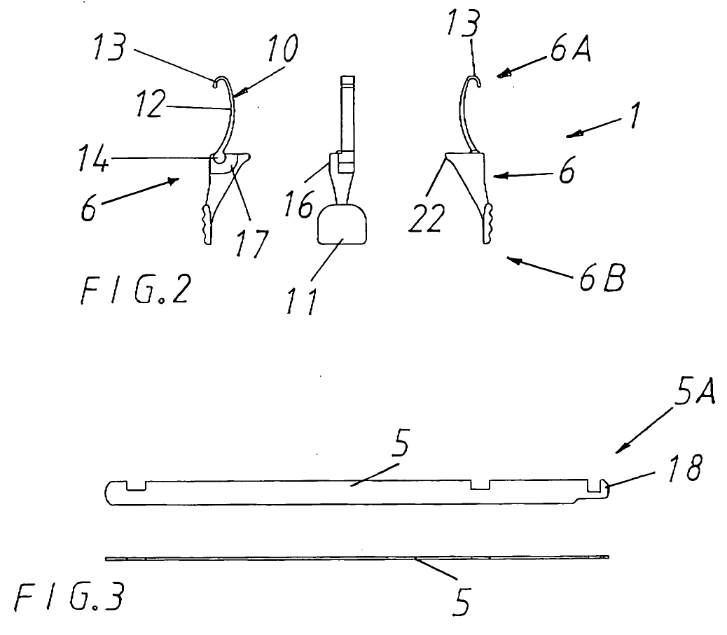

FIG. 2 shows a locking button from different sides;

FIG. 3 shows a locking rail from different sides;

FIGS. 4-7 show different assembly stages for assembly of a locking button to a locking rail.

FIGS. 8-11 show different positions for the actuation of a locking button in conjunction with its assembly in the back of a binder; and

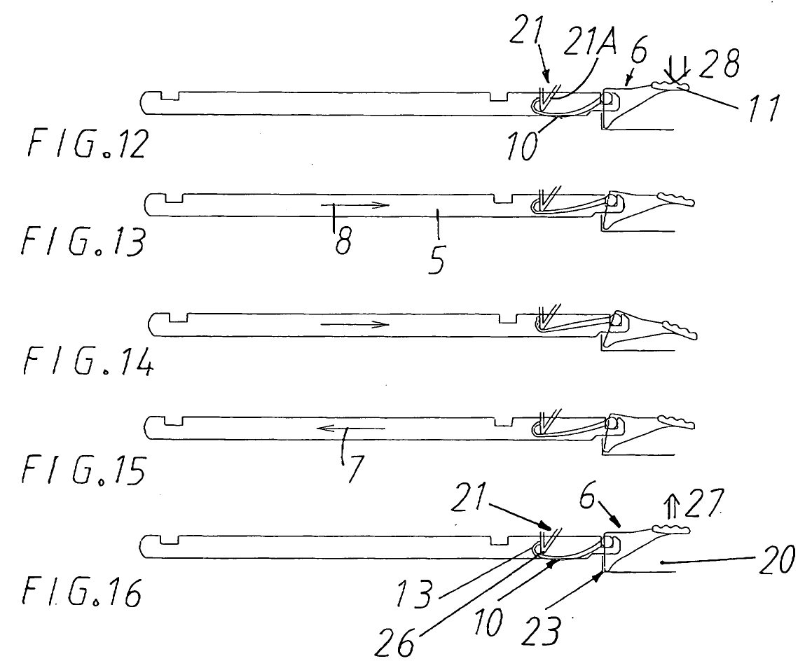

FIGS. 12-16 show different positions for the locking button in conjunction with its actuation.

An arrangement 1 for a locking mechanism 2 for a binder 3, which comprises a locking rail 5 that is detachably interconnectable with a number of hooks 4, which rail is capable of displacement by means of a manually actuated, spring-operated locking button 6 and is arranged at one end 3A of the binder, comprises, in accordance with the present invention, the execution of the locking button 6 executed in such a way that it performs both a spring function and a guiding function for the axially 7-8 mobile locking rail 5 and is detachably attachable to the locking rail 5 at its one end 5A. The locking mechanism 2 of the binder is used to lock the binder in different positions, that is to say closed or half-open. In order to achieve this function, a solution is offered here whereby a so-called locking button 6 is used together with a locking rail 5 which is installed in the back 9 of the binder. The locking button 6 is executed in such a way that it provides a spring function, which on the one hand acts as a secure means of locking the component to the back of the binder, and on the other provides a spring function when using the locking mechanism 2. This means that only two component parts, the locking button 6 together with the locking rail 5, provide a spring function. The entirely novel feature is thus that the button 6 has been combined with a spring 10 with two functions. This means not only simplified assembly, but also a simpler and more reliable function.

The locking button 6 preferably exhibits a spring and a push-button 11 at mutually opposite ends 6A and 6B, and it is formed by a single common part, for example as shown in FIG. 2, made of a plastic material.

The aforementioned spring 10 is in the form of a bow-shaped hook 12 with a curved end 13 at its outer end 6A, and the spring 10 starts from a thickened part 14, which forms a pivoting articulation for the locking button 6 in a recess 15 in the locking rail 5, as shown in FIGS. 4-7.

The aforementioned pivoting articulation 14 extends perpendicularly outwards from a laterally situated end wall 16 in the locking button 6, while a bow-shaped accommodating part 17 extends along the pivoting articulation 14 and is accommodated by a hook-shaped end part 18 of the locking rail 5.

The aforementioned back 9 of the binder exhibits a cavity 19 intended to accommodate the locking rail 5 and the spring 10 of the locking button 6 therein. The finger-operated push-button 11 of the locking button is capable of being accommodated by its pivoting articulation part 14 in an axially open part 20 of the said cavity 19, and the spring 10 makes contact with its end part 13 against a pointed part 21 in the back 9 of the binder. The locking button 6 also exhibits a pointed part 22, which is so arranged as to interact with an angled part 23 of the cavity 20 in the back of the binder in order to enable a support to be formed for the locking button 6 that is capable of pivotal actuation when it is pushed down with a finger, for example the thumb of the user who wishes to be able to open the binder 3 in question.

Assembly of the two loose component parts 5, 6 appropriately takes place as follows:

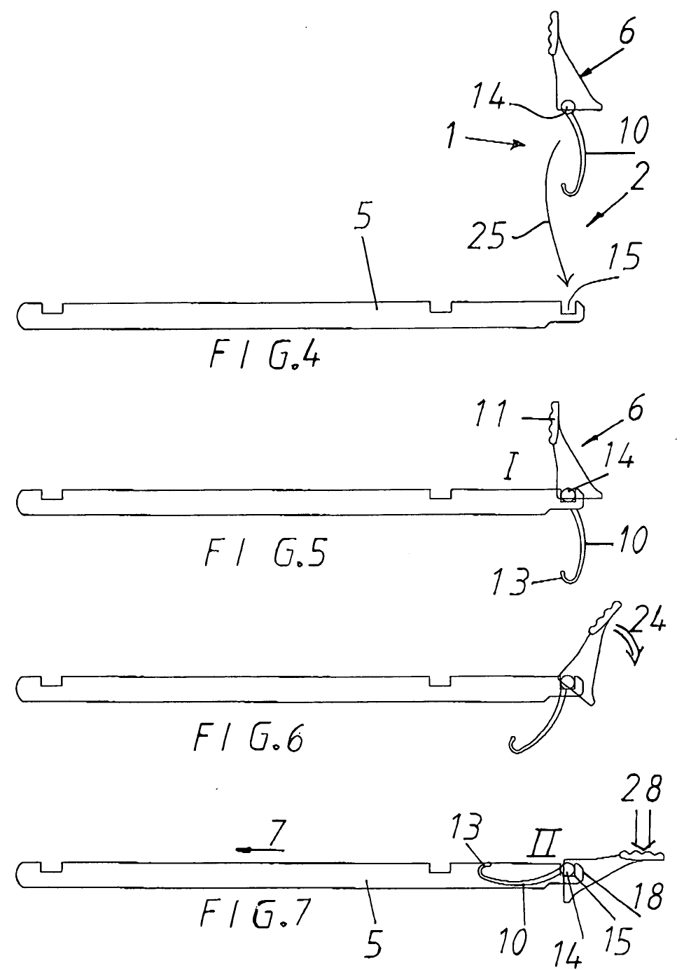

The locking button 6 is fitted to the locking rail 5 as shown in FIGS. 4 and 5 in the direction of the arrow 25, so that the thickened part 14 assumes a position in which it is accommodated in the matching recess 15 in the locking rail 5, whereupon the locking button 6 is rotated about the aforementioned articulation 14 from an angled installation position I to a straight installation position II in the direction of the arrow 24, in which straight installation position Ii the locking rail 5 together with the locking button 6 are ready for introduction axially in the direction of the arrow 7 and for installation in the back 9 of the binder.

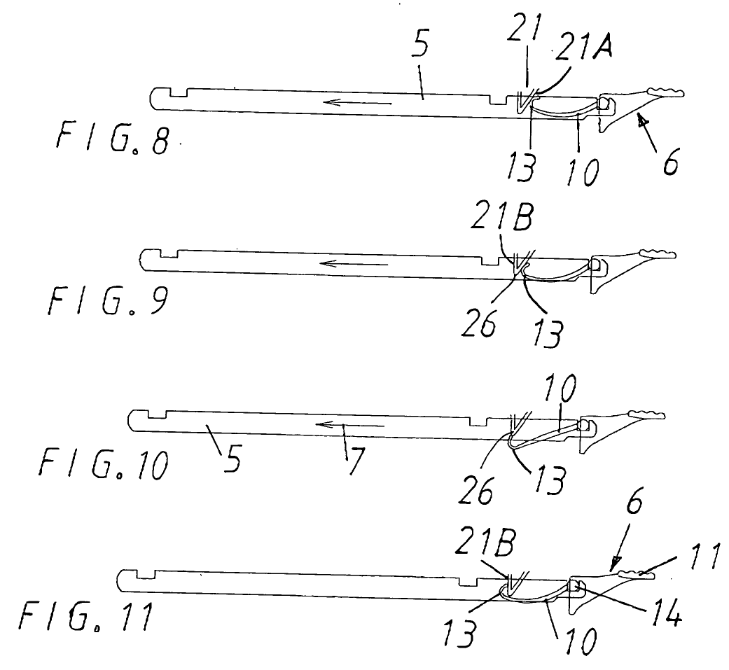

The aforementioned installation of the locking button 6 and the locking rail 5 in the back 9 of the binder is made possible by the presence in the back 9 of the binder of a hook 21 which serves the purpose of retaining the locking button 6 and the rail 5. The hook 21 is designed with an incline 21A, up which the strap 13 of the button can slide when the rail 5 is introduced into the back 9 of the binder in the direction of the arrow 7. FIG. 8 shows the starting position, and FIG. 9 shows the strap 13 as it starts to ascend one incline 21A of the hook. FIG. 10 shows clearly how the spring 10 with the sprung strap 13 of the button is extended, and then slides over the edge 26 of the hook. FIG. 11 shows the position when the strap 13 has sprung into position and is held in place so as to interact with the other straight incline 21B of the hook.

Disassembly of the mechanism takes place, as shown in FIG. 16, by taking hold of the locking button 6 and bending it upwards in the direction of the arrow 27, so that the spring strap 13 is able to pass freely under the hook 21 and its edge 26, and then to be pulled out.

The function between the locking button 6, the locking rail 5, the hook 21 of the back of the binder and the support 23 for the back of the binder is described in FIGS. 12-16. The locking button 6 and the locking rail 5 are retained securely in the binder 3 between the hook 21 of the back of the binder and the support 23 for the back of the binder, as shown in FIG. 12. Pressing the locking button 6 down in the direction of the arrow 28 causes the strap of the locking button 10 to be extended between the hook 21 of the back of the binder and the support 23 for the back of the binder. The locking rail 5, which is attached to the locking button 6, moves in the direction 8 of the arrow in accordance with FIGS. 13-14. The strap 10 of the locking button 6 has a spring function and causes the rail 5 to return to its original position, when the button 6 is not loaded as shown in FIGS. 15-16.

The invention is naturally not restricted to the embodiment described above and illustrated in the accompanying drawings. Modifications are possible, in particular with regard to the nature of the various component parts, or by the use of equivalent technology, but without departing from the area of protection afforded to the invention, as defined in the Patent claims.

1. Arrangement (1) for a locking mechanism (2) for a binder (3), which comprises a locking rail (5) that is detachably interconnectable with a number of hooks (4), which rail is capable of displacement by means of a manually actuated, spring-operated locking button (6), characterized in that the locking button (6) is executed in such a way that it performs both a spring function and a guiding function for the axially (7-8) mobile locking rail (5) and is detachably attachable to the locking rail (5) at its one end (5A).

2. Arrangement in accordance with Patent claim 1, characterized in that the locking button (6) exhibits a spring (10) and a push-button (11) at mutually opposite ends (6A, 6B).

3. Arrangement in accordance with Patent claim 2, characterized in that the locking button (6) is formed by a single common part.

4. Arrangement in accordance with Patent claim 3, characterized in that the locking button (6) consists of a plastic material.

5. Arrangement in accordance with one or other of Patent claims 2-4, characterized in that the aforementioned spring (10) is in the form of a bow-shaped hook (12) with a curved end (13).

6. Arrangement in accordance with Patent claim 5, characterized in that the spring (10) starts from a thickened part (14), which forms a pivoting articulation for the locking button (6) in the locking rail (5).

7. Arrangement in accordance with Patent claim 6, characterized in that the pivoting articulation (14) extends perpendicularly outwards from a laterally situated end wall (16) in the locking button (6).

8. Arrangement in accordance with Patent claim 7, characterized in that a bow-shaped accommodating part (17) extends along the pivoting articulation (14) for the accommodation of a hook-shaped end part (18) by the locking rail (5).

9. Arrangement in accordance with one or other of Patent claims 2-8, characterized in that the back (9) of the binder exhibits a cavity (19) to accommodate the locking rail (5) and the locking button (6) with its spring (10) therein, whereby the finger-operated push-button (11) of the locking button is capable of being accommodated by its pivoting articulation part (14) in an axially open part (20) of the said cavity (19), and the spring (10) makes contact with its end part (13) against a pointed part (21) in the back (9) of the binder.

10. Arrangement in accordance with one or other of Patent claims 6-9, characterized in that the locking button (6) exhibits a pointed part (22), which is so arranged as to interact with an angled part (23) of the cavity 20 in the back of the binder to enable a support to be formed for the locking button (6) that is capable of pivotal actuation.
